(19) United States
(12) Patent Application Publication
(10) Pub. No.: US 2010/0162240 A1
(43) Pub. Date: Jun. 24, 2010

(54) CONSISTENT SECURITY ENFORCEMENT FOR SAFER COMPUTING SYSTEMS

(75) Inventors: Xinwen Zhang, San Jose, CA (US); Jean-Pierre Seifert, Tirol (AT); Onur Aciicmez, San Jose, CA (US)

Correspondence Address: Beyer Law Group LLP, P.O. BOX 1687, Cupertino, CA, 95015-1687, US

(73) Assignee: SAMSUNG ELECTRONICS CO., LTD., Suwon City (KR)

(21) Appl. No.: 12/343,154

(22) Filed: Dec. 23, 2008

(51) Int. Cl. G06F 9/455

(52) U.S. Cl. 718/1

(57) ABSTRACT

Security can be enforced in a consistent manner with respect to various computing environments that may be operable in a computing system. Consistent security criteria can be generated, based on input security criterion, in a computer readable and storable form and stored in a computer readable storage medium, thereby allowing the consistent security criterion to be effectively provided to a computing system for enforcement of the input security criterion in a consistent manner with respect to, for example, (a) a first executable computer code effectively supported by an Operating System (OS), and (b) a second computer code effectively supported by the Virtual Computing Environment (VCE). A Trusted Component (TC) can effectively provide a consistent security criterion as a part and/or form that is suitable for a particular computing environment. The TC can, for example, be an automated tool that performs various functions including: verifying the consistency of security criteria, generation and deployment of consistent security criteria, and transformation of security criteria to parts and/or forms suitable for various computing environments. In addition, a Virtual Computing Environment (VCE) can obtain from the Operating System (OS) one or more security criteria. The Virtual Computing Environment (VCE) can be operable in a Trusted Computing Environment (TCE) and interface with a Trusted Operating System (TOS) that effectively enforces Mandatory Access Control (MAC), thereby allowing the Virtual Computing Environment (VCE) to leverage the security provided by the OS. The OS can, for example, be a Security-Enhanced Linux (SELinux) Operating System operating as a Trusted Component in a Trusted Environment that includes a Trusted Security Agent (TSA) operable to deploy consistent security criteria.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information is stored in a computer readable medium in a binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known as an Operating System (OS) which provides programmers with an interface used to access these resources and services.

Today, numerous types of computing devices are available. These computing devices widely range with respect to size, cost, amount of storage and processing power. The computing devices that are available today include: expensive and powerful servers, relatively cheaper Personal Computers (PC's) and laptops and yet less expensive microprocessors (or computer chips) provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

In particular, mobile communication devices (e.g., mobile phones) have become extremely popular. Some mobile communication devices (e.g., Smartphones) offer computing environments that are similar to that provided by a Personal Computer (PC). As such, a Smartphone can effectively provide a complete Operating System as a standardized interface and platform for application developers. Given the popularity of mobile communication devices, telecommunication is discussed in greater detail below.

Generally, telecommunication refers to assisted transmission of signals over a distance for the purpose of communication. In earlier times, this may have involved the use of smoke signals, drums, semaphore or heliograph. In modern times, telecommunication typically involves the use of electronic transmitters such as the telephone, television, radio or computer. Early inventors in the field of telecommunication include Alexander Graham Bell, Guglielmo Marconi and John Logie Baird. Telecommunication is an important part of the world economy and the telecommunication industry's revenue is placed at just under 3 percent of the gross world product.

Conventional telephones have been in use for many years. The first telephones had no network but were in private use, wired together in pairs. Users who wanted to talk to different people had as many telephones as necessary for the purpose. Typically, a person who wished to speak, whistled into the transmitter until the other party heard. Shortly thereafter, a bell was added for signaling, and then a switch hook, and telephones took advantage of the exchange principle already employed in telegraph networks. Each telephone was wired to a local telephone exchange, and the exchanges were wired together with trunks. Networks were connected together in a hierarchical manner until they spanned cities, countries, continents and oceans. This can be considered the beginning of the public switched telephone network (PSTN) though the term was unknown for many decades.

Public switched telephone network (PSTN) is the network of the world's public circuit-switched telephone networks, in much the same way that the Internet is the network of the world's public IP-based packet-switched networks. Originally a network of fixed-line analog telephone systems, the PSTN is now almost entirely digital, and now includes mobile as well as fixed telephones. The PSTN is largely governed by technical standards created by the ITU-T, and uses E.163/E.164 addresses (known more commonly as telephone numbers) for addressing.

More recently, wireless networks have been developed. While the term wireless network may technically be used to refer to any type of network that is wireless, the term is often commonly used to refer to a telecommunications network whose interconnections between nodes is implemented without the use of wires, such as a computer network (which is a type of communications network). Wireless telecommunications networks can, for example, be implemented with some type of remote information transmission system that uses electromagnetic waves, such as radio waves, for the carrier and this implementation usually takes place at the physical level or “layer” of the network (e.g., the Physical Layer of the OSI Model). One type of wireless network is a WLAN or Wireless Local Area Network. Similar to other wireless devices, it uses radio instead of wires to transmit data back and forth between computers on the same network. Wi-Fi is a commonly used wireless network in computer systems which enable connection to the internet or other machines that have Wi-Fi functionalities. Wi-Fi networks broadcast radio waves that can be picked up by Wi-Fi receivers that are attached to different computers or mobile phones. Fixed wireless data is a type of wireless data network that can be used to connect two or more buildings together in order to extend or share the network bandwidth without physically wiring the buildings together. Wireless MAN is another type of wireless network that connects several Wireless LANs.

Today, several mobile networks are in use. One example is the Global System for Mobile Communications (GSM) which is divided into three major systems which are the switching system, the base station system, and the operation and support system (Global System for Mobile Communication (GSM)). A cell phone can connect to the base system station which then connects to the operation and support station; it can then connect to the switching station where the call is transferred where it needs to go (Global System for Mobile Communication (GSM)). This is used for cellular phones and common standard for a majority of cellular providers. Personal Communications Service (PCS): PCS is a radio band that can be used by mobile phones in North America. Sprint happened to be the first service to set up a PCS. Digital Advanced Mobile Phone Service (D-AMPS) is an upgraded version of AMPS but it may be phased out as the newer GSM networks are replacing the older system.

Yet another example is the General Packet Radio Service (GPRS) which is a Mobile Data Service available to users of Global System for Mobile Communications (GSM) and IS-136 mobile phones. GPRS data transfer is typically charged per kilobyte of transferred data, while data communication via traditional circuit switching is billed per minute of connection time, independent of whether the user has actually transferred data or has been in an idle state. GPRS can be used for services such as Wireless Application Protocol (WAP) access, Short Message Service (SMS), Multimedia Messaging Service (MMS), and for Internet communication services such as email and World Wide Web access. 2G cellular systems combined with GPRS is often described as “2.5G”, that is, a technology between the second (2G) and third (3G) generations of mobile telephony. It provides moderate speed data transfer, by using unused Time Division Multiple Access (TDMA) channels in, for example, the GSM system. Originally there was some thought to extend GPRS to cover other standards, but instead those networks are being converted to use the GSM standard, so that GSM is the only kind of network where GPRS is in use. GPRS is integrated into GSM Release 97 and newer releases. It was originally standardized by European Telecommunications Standards Institute (ETSI), but now by the 3rd Generation Partnership Project (3GPP). W-CDMA (Wideband Code Division Multiple Access) is a type of 3G cellular network. W-CDMA is the higher speed transmission protocol used in the Japanese FOMA system and in the UMTS system, a third generation follow-on to the 2G GSM networks deployed worldwide. More technically, W-CDMA is a wideband spread-spectrum mobile air interface that utilizes the direct sequence Code Division Multiple Access signaling method (or CDMA) to achieve higher speeds and support more users compared to the implementation of time division multiplexing (TDMA) used by 2G GSM networks. It should be noted that SMS can be supported by GSM and MMS can be supported by 2.5G/3G networks.

Generally, a mobile phone or cell phone can be a long-range, portable electronic device used for mobile communication. In addition to the standard voice function of a telephone, current mobile phones can support many additional services such as SMS for text messaging, email, packet switching for access to the Internet, and MMS for sending and receiving photos and video. Most current mobile phones connect to a cellular network of base stations (cell sites), which is in turn interconnected to the public switched telephone network (PSTN) (one exception is satellite phones).

The Short Message Service (SMS), often called text messaging, is a means of sending short messages to and from mobile phones. SMS was originally defined as part of the GSM series of standards in 1985 as a means of sending messages of up to 160 characters, to and from Global System for Mobile communications (GSM) mobile handsets. Since then, support for the service has expanded to include alternative mobile standards such as ANSI CDMA networks and Digital AMPS, satellite and landline networks. Most SMS messages are mobile-to-mobile text messages, though the standard supports other types of broadcast messaging as well. The term SMS is frequently used in a non-technical sense to refer to the text messages themselves, particularly in non-English-speaking European countries where the GSM system is well-established.

Multimedia Messaging Service (MMS) is a relatively more modern standard for telephony messaging systems that allows sending messages that include multimedia objects (images, audio, video, rich text) and not just text as in Short Message Service (SMS). It can be deployed in cellular networks along with other messaging systems like SMS, Mobile Instant Messaging and Mobile E-mal. Its main standardization effort is done by 3GPP, 3GPP2 and Ope Mobile Alliance (OMA).

The popularity of computing systems, especially mobile communication devices, is evidenced by their ever increasing use in everyday life. As such, further enhancement to computing systems would be useful.

### SUMMARY OF THE INVENTION

The invention relates to computing environments and computing systems. More particularly, the invention pertains to techniques for enforcing security in computing environments and computing systems.

In accordance with one aspect of the invention, consistent security criteria can be provided for enforcement of security with respect to multiple computing environments. In one embodiment, one or more consistent security criteria are generated, based on input security criterion, in a computer readable and storable form and stored in a computer readable storage medium, thereby allowing the consistent security criterion to be effectively provided to a computing system for enforcement of the input security criterion in a consistent manner with respect to (a) a first executable computer code effectively supported by an Operating System (OS), and (b) a second computer code effectively supported by the Virtual Computing Environment (VCE).

It will be appreciated that a safe component (e.g., a Trusted Agent) can effectively provide one or more consistent security criteria in accordance with another aspect of the invention. In one embodiment, a Trusted Component (TC) can effectively provide a consistent security criterion to an Operating System (OS) and a Virtual Computing Environment (VCE). It will be appreciated that a component (e.g., a tool) can be operable to provide the consistent security criterion as a part and/or form that is suitable for each of the Operating System (OS) and a Virtual Computing Environment (VCE). By way of example, a Trusted Security Agent (TSC) can provide a consistent security criterion in a first form or as first part for a Virtual Machine (VM) and as a second form or second part for an Operating System (OS). The Trusted Security Agent (TSC) may also provide a security label mapping that can be effectively used to map security labels between an Operating System and a Virtual Machine (VM) as will be appreciated by those skilled in the art. In general, a component (e.g., a tool) can be operable to perform various functions including verifying consistency of security criteria, generation and deployment of consistent security criteria, and transformation of security criteria to parts and/or forms suitable for various computing environments.

In accordance with a related aspect of the invention, a consistent security criterion can be enforced by an Operating System (OS) and a Virtual Computing Environment (VCE). In one embodiment, a consistent security criterion for enforcement of a security criterion in a consistent manner with respect to a first executable computer code and second computer code effectively supported by a Virtual Computing Environment (VCE) is obtained. Security in the computing system can be enforced in accordance with the consistent security criterion, thereby enforcing security in a consistent manner with respect to the first executable computer code and second computer code.

In accordance with a yet another aspect of the invention, a Virtual Computing Environment (VCE) can obtain one or more security criteria that can be enforced by an Operating System (OS). Typically, the one or more security criteria are stored and/or maintained by the Operating System (OS). In one embodiment, a Virtual Computing Environment (VCE) is operable to obtain from an Operating System (OS) at least one of a set of security criteria and enforce it with respect to computer code effectively supported by that the Virtual Computing Environment (VCE). It will be appreciated that the one or more security criteria can be consistent security criteria provided in accordance with the invention. In addition, the Virtual Computing Environment (VCE) can be operable in a Trusted Computing Environment (TCE) and as such interface with a Trusted Operating System (OS). It will be appreciated that the Operating System (OS) can be a secure OS that effectively enforces Mandatory Access Control (MAC), thereby allowing the Virtual Computing Environment (VCE) to leverage the security provided by the OS. In one embodiment, the OS is a Security-Enhanced Linux (SELinux) Operating System (OS) operating as a Trusted Component in a Trusted Environment that includes a Trusted Security Agent (TSA) operable to deploy consistent security criteria.

The invention can be implemented in numerous ways, including, for example, a method, an apparatus, a computer readable (and/or storable) medium, and a computing system (e.g., a computing device). A computer readable medium can, for example, include at least executable computer program code stored in a tangible form. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a security criteria generator in a computing environment in accordance with one embodiment of the invention.

FIG. 1B depicts a computing system in accordance with one embodiment of the invention.

FIG. 1C depicts a method for generating one or more consistent security criteria in accordance with one embodiment of the invention.

FIG. 1D depicts a method for security a computing system in accordance with one embodiment of the invention.

FIG. 2A depicts a computing system in accordance with one embodiment of the invention.

FIG. 2B depicts a method for securing a Virtual Computing Environment (VCE) in accordance of one embodiment of the invention.

FIG. 3 depicts a computing system in accordance with one embodiment of the invention.

### DETAILED DESCRIPTION OF THE INVENTION

As noted in the background section, mobile devices are becoming increasingly more popular. Today, wireless networks and mobile communication devices (e.g., Smartphones, cell phones, Personal Digital Assistants) are especially popular. Unfortunately, however, partly because of this popularity, more and more malicious attacks are being directed to wireless networks and mobile communication devices. In addition, recent developments, including relatively new services (e.g., email, file transfer and messaging), and use of common software platforms (e.g., Symbian, Embedded Linux, and Windows CE Operating Systems) has made mobile communication devices relatively more exposed to malicious attacks. The exposure to malicious attacks could worsen as the wireless networks and mobile communication devices continue to evolve rapidly. Today, wireless and/or portable communication devices (e.g., cell phones, Smartphones) can offer similar functionality as that more traditionally offered by Personal Computers (PCs). As a result, wireless and/or portable communication devices are likely to face similar security problems (e.g., worms, viruses) as those encountered in more traditional computing environments.

Examples of the most notorious threats to cell phones include the Skull, Cabir, and Mabir worms which have targeted the Symbian Operating Systems. Generally, an MMS-based worm can start attacking initial targets (hit-list) from the network. Each infected phone can scan its contact list and randomly pick up members to deliver a malicious attack in the form of a message. A person can trust an incoming message due to its attractive title or seemingly familiar source and activate the attached file and unwittingly get a phone infected. The infected phone can in turn get other phones infected, and so on. In contrast, a Blue-tooth based worm can take control of a victim phone's Blue-tooth interface and continuously scan for other Blue-tooth-enabled phones within its range. Once a new target has been detected, the worm can effectively connect to other devices and transfers a malicious message to them, and so on.

Taking the cell phone as an example, an active cell phone typically has two security states: susceptible and infected. A susceptible cell phone is not completely protected against worms and may get infected when exposed to a specific worm (e.g., CommWarrior). An infected cell phone can return back to the susceptible state when the user launches a protection (e.g., the CommWarrior patch from F-Secure or Symantec) partly because the cell phone is susceptible to other worm threats. Malware has many other undesirable affects including compromising the privacy of the users.

Generally, security of the computing systems (e.g., computing devices) is a major concern today, yet it is also desirable to support executable code (e.g., application programs) provided by various entities. Modern computing system can effectively provide a Virtual Computing Environment (VCE) (e.g., a virtual machine) supporting platform independent application programs that may not be directly supported by the Operating System (OS) (e.g., Applets for mobile computing environments) and native applications that can be directly supported by Operating System (OS) (e.g., applications that are designed for a particular Operating System (OS)).

However, security criteria (e.g., security policies, security rules, security conditions) may not be provided in a consistent manner with respect to virtual and native computing environments and consequently result in compromising the overall security of the computing system. Another problem may be the redundancy of different sets of security criteria typically defined by different entities (e.g., various stakeholders such as, for example, device manufactures, service providers, application providers of a mobile phone).

In view of the foregoing, techniques that can improve the security of computing systems would be very useful.

The invention relates to computing environments and computing systems. More particularly, the invention pertains to techniques for enforcing security in computing environments and computing systems.

In accordance with one aspect of the invention, consistent security criteria can be provided for enforcement of security with respect to multiple computing environments. In one embodiment, one or more consistent security criteria are generated, based on input security criterion, in a computer readable and storable form and stored in a computer readable storage medium, thereby allowing the consistent security criterion to be effectively provided to a computing system for enforcement of the input security criterion in a consistent manner with respect to (a) a first executable computer code effectively supported by an Operating System (OS), and (b) a second computer code effectively supported by the Virtual Computing Environment (VCE).

It will be appreciated that a safe component (e.g., a Trusted Agent) can effectively provide one or more consistent security criteria in accordance with another aspect of the invention. In one embodiment, a Trusted Component (TC) can effectively provide a consistent security criterion to an Operating System (OS) and a Virtual Computing Environment (VCE). It will be appreciated that a component (e.g., a tool) can be operable to provide the consistent security criterion as a part and/or form that is suitable for each of the Operating System (OS) and a Virtual Computing Environment (VCE). By way of example, a Trusted Security Agent (TSC) can provide a consistent security criterion in a first form or as first part for a Virtual Machine (VM) and as a second form or second part for an Operating System (OS). The Trusted Security Agent (TSC) may also provide a security label mapping that can be effectively used to map security labels between an Operating System and a Virtual Machine (VM) as will be appreciated by those skilled in the art. In general, a component (e.g., a tool) can be operable to perform various functions including verifying consistency of security criteria, generation and deployment of consistent security criteria, and transformation of security criteria to parts and/or forms suitable for various computing environments.

In accordance with a related aspect of the invention, a consistent security criterion can be enforced by an Operating System (OS) and a Virtual Computing Environment (VCE). In one embodiment, a consistent security criterion for enforcement of a security criterion in a consistent manner with respect to a first executable computer code and second computer code effectively supported by a Virtual Computing Environment (VCE) is obtained. Security in the computing system can be enforced in accordance with the consistent security criterion, thereby enforcing security in a consistent manner with respect to the first executable computer code and second computer code.

In accordance with a yet another aspect of the invention, a Virtual Computing Environment (VCE) can obtain one or more security criteria that can be enforced by an Operating System (OS). Typically, the one or more security criteria are stored and/or maintained by the Operating System (OS). In one embodiment, a Virtual Computing Environment (VCE) is operable to obtain from an Operating System (OS) at least one of a set of security criteria and enforce it with respect to computer code effectively supported by that the Virtual Computing Environment (VCE). It will be appreciated that the one or more security criteria can be consistent security criteria provided in accordance with the invention. In addition, the Virtual Computing Environment (VCE) can be operable in a Trusted Computing Environment (TCE) and as such interface with a Trusted Operating System (OS). It will be appreciated that the Operating System (OS) can be a secure OS that effectively enforces Mandatory Access Control (MAC), thereby allowing the Virtual Computing Environment (VCE) to leverage the security provided by the OS. In one embodiment, the OS is a Security-Enhanced Linux (SELinux) Operating System (OS) operating as a Trusted Component in a Trusted Environment that includes a Trusted Security Agent (TSA) operable to deploy consistent security criteria.

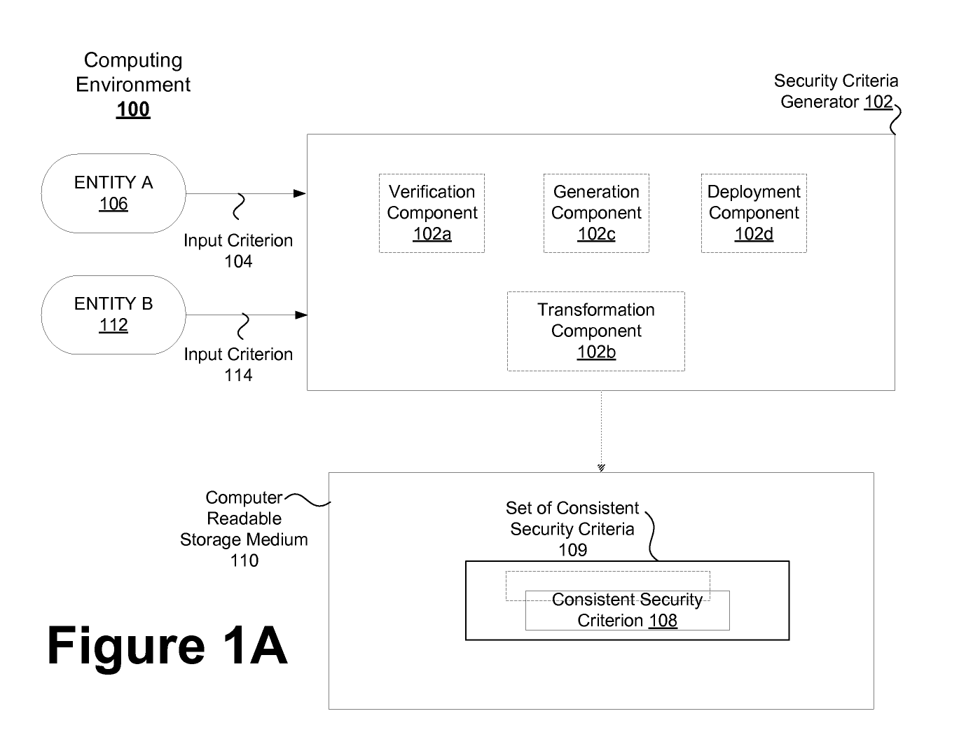

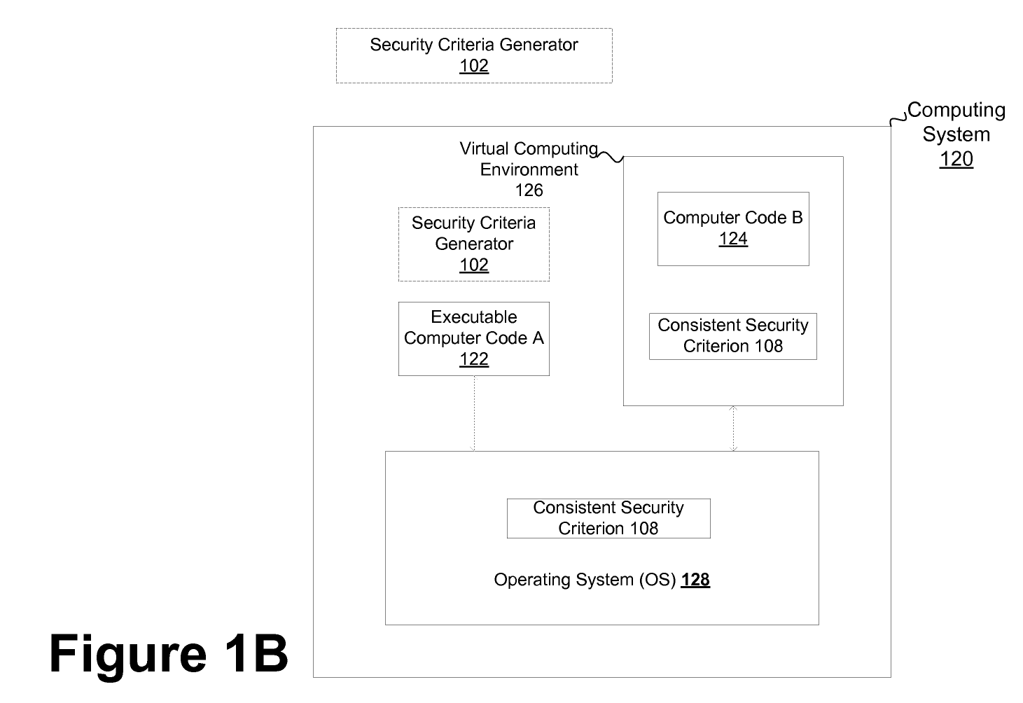

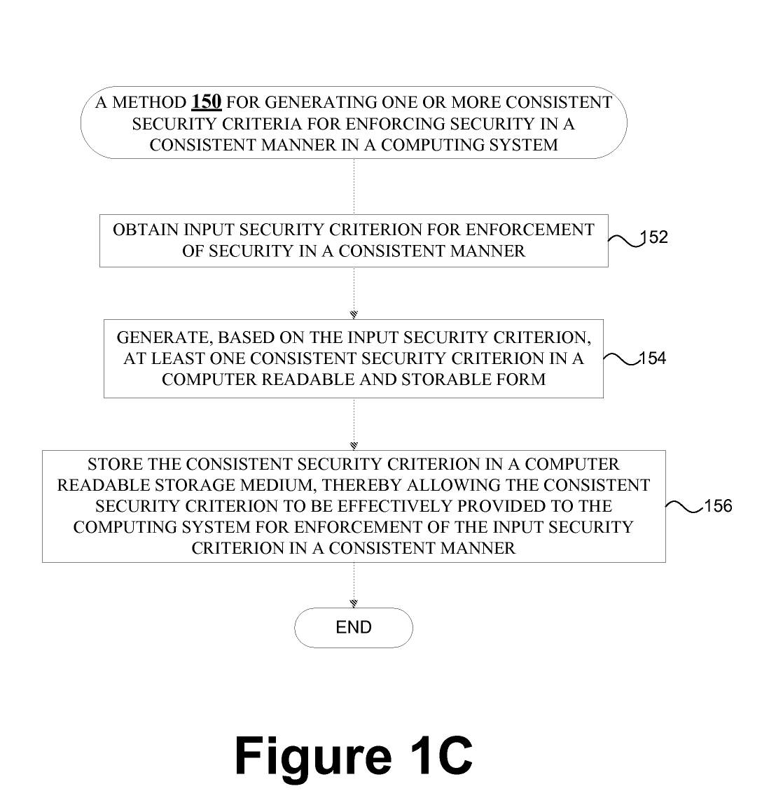

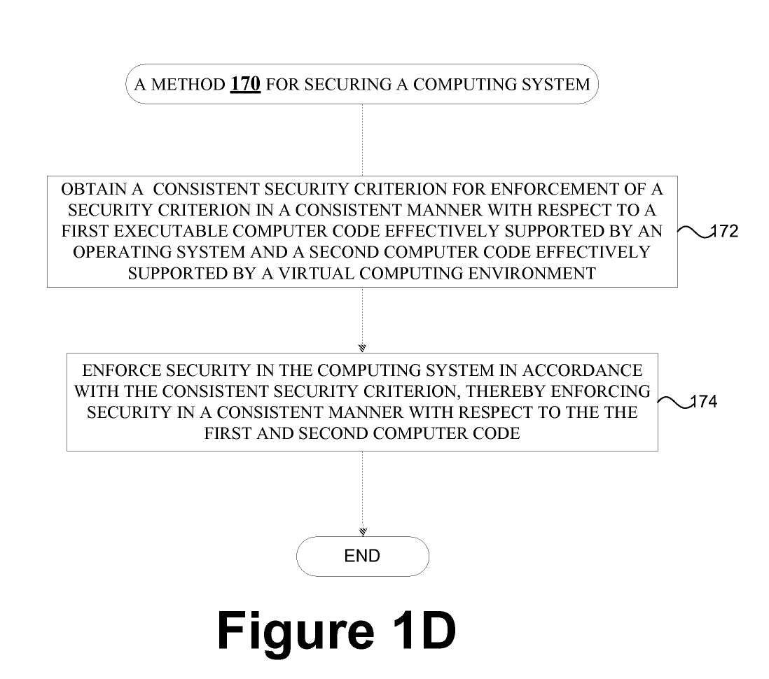

Embodiments of these aspects of the invention are discussed below with reference to FIGS. 1A-3. However, those skilled in the art will readily appreciate that the detailed description given herein with respect to these figures is for explanatory purposes as the invention extends beyond these limited embodiments.

FIG. 1A depicts a security criteria generator 102 in a computing environment 100 in accordance with one embodiment of the invention. Referring to FIG. 1A, the security criteria generator 102 is operable to receive an input security criterion 104. The input security criterion 104 can, for example, be effectively provided by an entity 106. It will be appreciated that an entity 106 can effectively define and/or provide the input security criterion 104 for enforcement of security in a consistent manner with respect to execution of various executable components of the computing environment 100. Generally, input security criteria can be provided for enforcement of security with respect to various components of a computing environment and/or computing system. In particular, referring back to FIG. 1A, the input security criterion 104 can be a criterion for enforcement of security in a consistent manner with respect to execution of a first executable computer code effectively supported by an Operating System (OS) (e.g., executable computer code 122 for the Operating System 128 as depicted in FIG. 1B) and a second computer code effectively supported by a Virtual Computing Environment (VCE) (e.g., executable computer code 124 effectively supported by a Virtual Computing Environment (VCE) 126 that interfaces with the Operating System 128 as depicted in FIG. 1B). Moreover, it will be appreciated that the security criteria generator 102 can be operable to generate a security criterion in a form that can be used by a computing system to enforce security in a consistent manner with respect to various components of a computing system (“consistent security criteria”) based on the input security criterion 104, thereby allowing enforcement of security in a consistent manner with respect to various components of the computing system including executable computer code supported by an Operating System (OS) and computer code effectively supported by a Virtual Computing Environment (VCE).

Those skilled in the art will appreciate that the consistent security criterion 108 can be stored in a computer readable storage medium 110 in a form that can be accessed by a computing system, thereby allowing it to be provided to the computing system for enforcement of security in a consistent manner. Referring to FIG. 1A, the security criteria generator 102 can include a verification component 102a operable to perform various functions related to verification of the input security criteria 104, an ultimately generation of the consistent security criteria 108. As such, the verification component 102a can be operable to verify the consistency of the input security criteria 104 with another security criteria, namely, the input security criteria 114. The second input criterion 114 can, for example, be provided by a second entity 112. The first and second entities 106 and 112 can, for example, represent various stakeholders (e.g., manufacturers, providers, application developers, end users) that provide various security criteria for enforcement in a computing system or environment. The verification component 102a can verify that security criteria 104 and 114 are not in conflict, intended to be enforced in a consistent manner with respect to various computing components and/or computing systems. In addition to the verification component 102a, the security criteria generator 102 can also include a transformation component 102b. As will be appreciated, the transformation component 102b can be operable to allow a generation component 102c to effectively generate the consistent security criteria 108 in various forms intended for various computing components and possibly different computing systems. In particular, the transformation component 102b can be operable to effectively allow generation of a security criterion 108 in a form and/or portion intended for a Virtual Computing Environment (VCE) and in a different form or portion intended for use by an Operating System (OS). Those skilled in the art will also appreciate that the transformation component 102b can be operable to facilitate generation of data needed for effective mapping of the security labels between a Virtual Computing Environment (VCE) and an Operating System (OS) environment. In addition, the security criteria generator 102 can also provide a deployment component 102d operable to effectively provide the consistent security criteria 108 in parts or various forms suitable for various computing environments and/or computing components. Generally, a set of consistent security criteria 109 can be provided as a comprehensive solution for securing one or more computing systems in a consistent manner.

To further elaborate, FIG. 1B depicts a computing system 120 in accordance with one embodiment of the invention. It will be appreciated that the computing system 120 can be operable to effectively use one or more consistent security criteria (e.g., a consistent security criterion 108 depicted in FIG. 1A) in order to enforce security in a consistent manner with respect to executable computer code B (124) that is effectively supported by a Virtual Computing Environment (VCE) 126 and executable computer code A (122) that is effectively supported by an Operating System (OS) 128. As will be appreciated by those skilled in the art, the executable computer code A (122) can directly interface with the Operating System (OS) 128. As such, the executable computer code A (122) can, for example, represent executable computer code of various native applications that may be operable in the computing system 120. On the other hand, the executable computer code B can be effectively supported and/or executed by a Virtual Computing Environment (VCE) 126 (e.g., a virtual machine). Typically, the Virtual Computing Environment (VCE) 126 is operable to interface with the Operating System (OS) 128. The computer code B (124) can be operating-system independent code (e.g., Java™ programming code supported by a Java™ Virtual Machine (VM)).

The computing system 120 can be operable to obtain the consistent security criterion 108 and store it in the Virtual Computing Environment (VCE) 126 and the Operating System (OS) 128. The consistent security criterion 108 can, for example, be generated and/or provided by the security criteria generator 102 depicted in FIG. 1A. In other words, the deployment component 102b of the security criteria generator 102 (depicted in FIG. 1A) can be operable in the computing system 120 to effectively provide the consistent security criteria 108 to both the Virtual Computing Environment (VCE) 126 and the Operating System (OS) 128. In other words, the security criteria generator 102 can be a part of the computing system 120. As such, the security criteria generator 102 (shown in FIG. 1A) can be effectively provided for a computing device (e.g., a personal computer, a cell phone, a smart phone, a laptop). Alternatively, the computing system 120 (depicted in FIG. 1B) can be operable to communicate with the security criteria generator 102 (depicted in FIG. 1A) provided as and/or by an external device (e.g., a server) with respect to the computing system 120. As noted above, the consistent security criteria 108 can effectively be provided in various forms that accommodate both the Virtual Computing Environment (VCE) 126 and the Operating System (OS) 128.

Moreover, a Virtual Computing Environment (VCE) (e.g., the Virtual Computing Environment (VCE) 126) can be operable to effectively interface with an Operating System (OS) (e.g., the Operating System (OS) 128) in order to obtain security criteria including a consistent security criterion (e.g., the consistent security criteria 108) stored and or effectively maintained by the Operating System (OS).

FIG. 1C depicts a method 150 for generating one or more consistent security criteria in accordance with one embodiment of the invention. It will be appreciated that a consistent security criterion can be effectively used with force security in a consistent manner with respect to various computing environments operating in a computing system. The method 150 can, for example, be used by the security criteria generator 102 depicted FIG. 1A.

Referring to FIG. 1C, initially, an input security criterion for enforcement of security in a consistent manner is obtained (152). Next, at least one consistent security criterion is generated (154) based on the input security criterion. It should be noted that the consistent security criterion is generated (154) in a computer readable and storable form. As such, the consistent security criterion is stored (156) in a computer readable storage medium, thereby allowing the consistent security criterion to be effectively provided to a computing system for enforcement of the input security criterion in a consistent manner with respect to various computing environments that may be operating in the computing system. The method 150 ends after the consistent security criterion is stored (156) in a computer readable storage medium. It will be apparent and appreciated that the method 150 can be repeated. By way of example, the method 150 can be repeated for multiple stakeholders that each provide input security criterion.

FIG. 1D depicts a method 170 for security a computing system in accordance with one embodiment of the invention. The method 170 can, for example, be used by the computing system 120 depicted in FIG. 1B. Referring to FIG. 1D, initially, a consistent security criterion is obtained (172). It should be noted that the consistent security criterion is suitable for enforcing security in a consistent manner with respect to a first executable computer code effectively supported by an Operating System (OS) and a second computer code effectively supported by a Virtual Computing Environment (VCE). After the consistent security criterion has been obtained (172), security is enforced (174) in accordance with the consistent security criterion, thereby enforcing security in a consistent manner with respect to the first and second computer codes respectively operable in the Operating System (OS) and Virtual Computing Environment (VCE). The method 170 ends after security has been enforced (174) in accordance with the consistent security criterion.

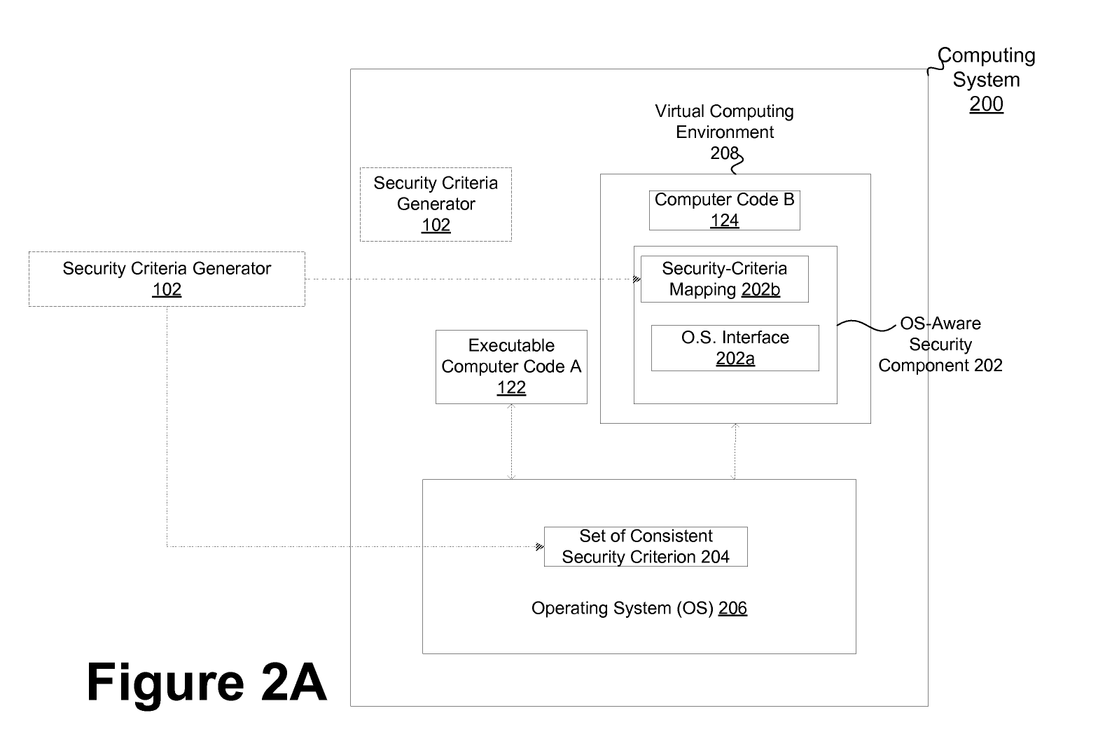

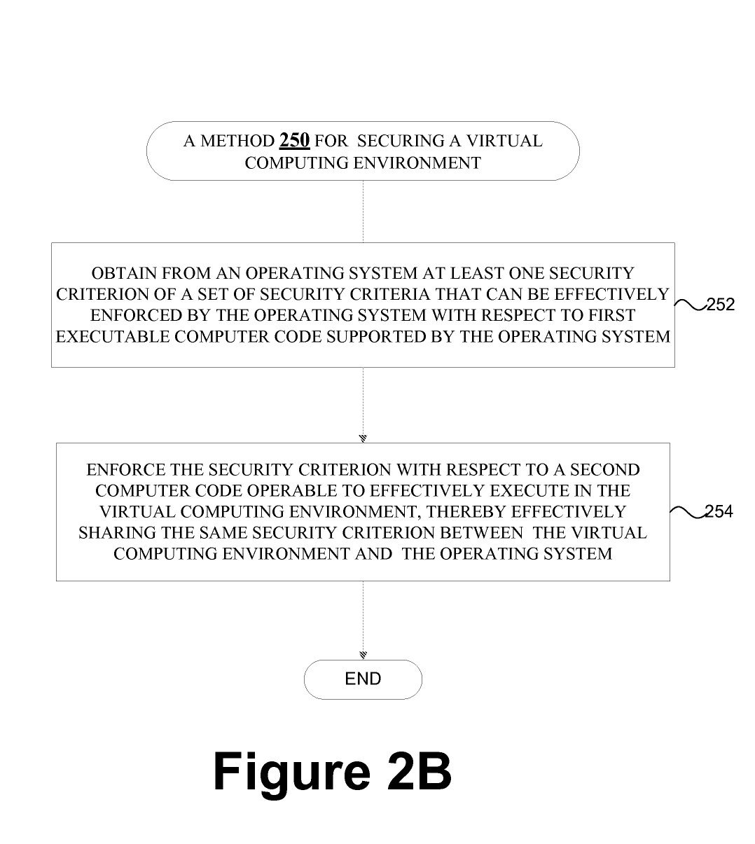

FIG. 2A depicts a computing system 200 in accordance with one embodiment of the invention. Referring to FIG. 2A, an Operating System-aware security component 202 can be operable to obtain a set of security criteria 204 from an Operating System (OS) 206 in order to allow enforcement of security with respect to computer program code B (124) effectively supported by the Virtual Computing Environment (VCE) 208. More specially, an Operating System (OS) interface 202a of the Operating-System aware security component 202 can effectively interface with an Operating System (OS) security system 210 in order to obtain one or more security criteria from the set of security criteria 204 effectively maintained and/or secured by the Operating System (OS) 206. Those skilled in the art will readily appreciate that the Operating System (OS) interface 202a of the operating-system aware security component 202 may be provided using readily available programming interfaces and/or libraries of the Operating System (OS) 206. By way of example, the Operating System (OS) interface 202a can include a Programming Interface and/or Library of a Security-Enhanced Linux Operating System (OS) (SELinux).

In addition, security-criteria mapping 204b can effectively allow mapping of a security criterion 204 of the Operating System (OS) 206 to a security criteria that can be effectively understood and enforced by the Operating System-aware security component 202 in the Virtual Computing Environment (VCE) 208. As will be appreciated by those skilled in the art, the security-criteria mapping 204b can, for example, include mapping data that can be effectively used to map a security label that is originally provided and/or intended for the Operating System (OS) 206 to a security label of the Virtual Computing Environment (VCE) 208.

It will be appreciated that the set of security criteria 204 stored and/or maintained, the Operating System (OS) 209 can include one or more consistent security criteria provided for enforcement of security in a consistent manner with respect to computer code B (124) associated with the Virtual Computing Environment (VCE) 208 and executable computer code A (122) directly supported by the Operating System (OS) 206. It should be noted that a security criteria generator 102 (also shown in FIG. 1A) may be operable to effectively provide the set of security criteria 204 as a consistent set of security criteria, as suggested by FIG. 2. In addition, the security criteria generator 102 can provide the security criteria mapping 204b and/or a corresponding set of consistent security criterion in a form that can be used by the Virtual Computing Environment (VCE) 208.

FIG. 2B depicts a method 250 for securing a Virtual Computing Environment (VCE) in accordance of one embodiment of the invention. The method 250 can, for example, be used by the computing system 200 depicted in FIG. 2A. Referring to FIG. 2B, initially, a security criterion is obtained (252) from an Operating System (OS). Typically, the security criterion is obtained from a set of security criteria that can be enforced by the Operating System (OS). Generally, an Operating System (OS) can enforce a security criterion with respect to first executable computer code supported by the Operating System (OS) (e.g., native code directly supported by an Operating System (OS)). The security criterion is enforced (254) with respect to a second computer code operable to effectively execute in a Virtual Computing Environment (VCE), thereby effectively enforcing in the Virtual Computing Environment (VCE) a security criterion that can be enforced by the Operating System (OS) with respect to first executable computer code. In this way, a security criterion can be effectively shared between the Virtual Computing Environment (VCE) and the Operating System (OS). As a result, security can be enforced in consistent manner. The method 250 ends after enforcing (254) of the security criterion.

Referring back to FIG. 1B, it will also be appreciated that a security criteria generator 102 and/or one of its components can be provided as a Safe component (e.g., a Trusted Component as will be known to those skilled in the art) in accordance with one aspect of the invention. Given the prevalence of mobile computing environments and the benefits that trusted computing can provide, an exemplary computing system that is especially suitable for providing a mobile computing system and can utilizes Trusted Computing technology is discussed below.

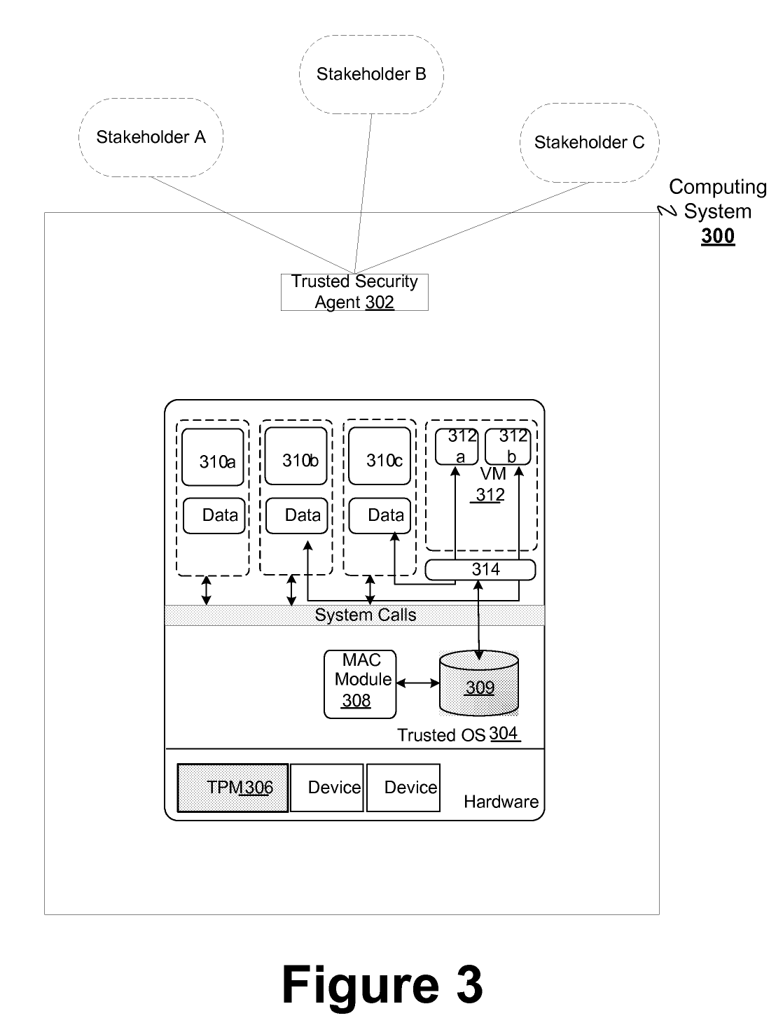

FIG. 3 depicts a computing system 300 in accordance with one embodiment of the invention. Referring to FIG. 3, a trusted security agent 302 can be operable as a trusted security criteria generator (e.g., a security criteria generator 102 depicted in FIG. 1A). As such, the security criteria generator 102 can, for example, provide verification, generation, deployment, and/or transformation functionality similar to that which can be provided by the security criteria generator 102 depicted in FIG. 1A. However, as a trusted component the integrity of the trusted security agent 302 can be verified before allowing it to operate as a trusted component of the computing system 300, as will be known to those skilled in the art. For example, the integrity of the security agent 302 can be verified by a Trusted Operating System (TOS) 304 (or a trusted kernel) that is operable as a trusted component after its integrity has been verified by other trusted components, namely, a Trusted Platform Module (TPM) 306 that can, for example, be and/or include a Mobile Trusted Module (MTM) suitable for a mobile computing environment as will be known to those skilled in the art. The Trusted Operating System (TOS) 304 can include a Mandatory Access Control (MAC) module 308 for a more secure operating environment. As such, the Trusted Operating System (TOS) 304 can, for example, be a Security-Enhanced Linux (SELinux) Operating System providing Mandatory Access Control (MAC). Referring to FIG. 3, various native applications 310a, 310b and 310c can be supported by the Trusted Operating System (TOS) 304. The native applications 310a, 310b and 310c can be respectively associated with stakeholders A, B and C representing, for example, a device manufacture, a service provider, and an application and/or user-program developer. It should be noted that one or more security criteria 309 including, for example, security policies, rules and/or conditions effectively enforced by the Mandatory Access Control (MAC) module 308 with respect to the native applications 310a, 310b and 310c, for example, using the techniques described in the patent application Ser. No. 11/963,363 entitled “TRUSTED MULTI-STAKEHOLDER ENVIRONMENT,” which is hereby incorporated herein by reference for all purposes.

In addition, the Virtual Computing Environment (VCE) represented as the Virtual Machine (VM) 312 (e.g., a KVM provided as a VM for a mobile device as generally known in the art) can be operable to access the security criteria 309 via operating-system Libraries and/or Interfaces 314 (e.g., “SELinux.lib” of a SELinux Operating System). In other words, the Virtual Machine (VM) 312 can include an operating-system security system or component (e.g., operating-system security component 202 depicted in Figure). The operating-system Libraries and/or Interfaces 314 effectively allow the Virtual Machine (VM) 312 to obtain the security criteria 309 and enforce them with respect to various applications 312a and 312b that can, for example, be developed and/or provided by various entities (e.g., a user MiDlet developed by an application developer and a service provider MiDlet developed by a service provider).

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of generating one or more consistent security criteria for enforcing security in a consistent manner with respect to: (a) execution of first executable computer code effectively supported by an Operating System of a computing system and (b) execution of second computer code effectively supported by a Virtual Computing Environment that can interface with said Operating System, wherein said method comprises:
obtaining input security criterion for enforcement of security in a consistent manner with respect to execution of: (a) said first executable computer code effectively supported by said Operating System, and (b) said second computer code effectively supported by said Virtual Computing Environment;
generating, based on said input security criterion, at least one consistent security criterion in a computer readable and storable form, thereby allowing said consistent security criterion to be stored in a computer readable storage medium as a consistent security criterion for enforcement of security in a consistent manner with respect to execution effectively supported by said Operating System and said Virtual Computing Environment; and
storing said at least one consistent security criterion in said computer readable storage medium as stored consistent security criterion, thereby allowing said stored consistent security criterion to be effectively provided to said computing system for enforcement of said input security criterion in said consistent manner.

2. The computer-implemented method of claim 1,
verifying said input security criterion for consistency with one or more other input consistent security criterion and/or one or more other stored consistent security criteria; and
generating said at least one consistent security criterion in said computer readable and storable form when said verifying successfully verifies said consistency.

3. The computer-implemented method of claim 2, wherein said generating generates said at least one consistent security criterion in said computer readable and storable form only when said verifying successfully verifies said consistency.

4. The computer-implemented method of claim 2, wherein said method further comprises:
effectively providing said stored consistent security criterion to said Virtual Computing Environment and/or Operating System.

5. The computer-implemented method of claim 4, wherein said effectively providing of said stored consistent security criterion to said Virtual Computing Environment and/or Operating System comprises:
effectively providing by a safe computing component said stored consistent security criterion to said Virtual Computing Environment and/or Operating System.

6. The computer-implemented method of claim 4, wherein said safe deployment computing component includes a trusted deployment computing component.

7. The computer-implemented method of claim 2, wherein said verifying of said input security criterion and/or said generating of said at least one consistent security criterion comprise of one or more of the following:
verifying, by a safe criterion-verification component, said for consistency with one or more other input consistent security criterion and/or one or more other stored consistent security criterion; and
generating, by a safe criterion-generation component, said at least one consistent security criterion in said computer readable and storable form when said verifying by a said safe criterion-verification component successfully verifies said consistency.

8. The computer-implemented method of claim 7, wherein said safe criterion-verification component and said safe criterion-verification component are trusted components effectively provided by a trusted tool operable to verify said input security criterion and to generate said consistent security criterion.

9. The computer-implemented method of claim 8, wherein said trusted tool is further operable to store said consistent security criterion on said Operating System and/or virtual computing environment.

10. The computer-implemented method of claim 8, wherein said method further comprises:
receiving said input security criterion as input defined and/or provided by a person.

11. The computer-implemented method of claim 1, wherein said Virtual Computing Environment includes a virtual machine.

12. The computer-implemented method of claim 11,
wherein said virtual machine is Java™ compliant Virtual Machine (JVM),
wherein said second computer code pertains to a Java™ Application, and
wherein said first executable computer code pertains to a native application.

13. The computer-implemented method of claim 12,
wherein said Java™ compliant Virtual Machine (JVM) is a KVM, and
wherein said second computer code pertains to a Java™ compliant Applet.
wherein said first executable computer code pertains to a native application.

14. The computer-implemented method of claim 13,
wherein said Java™ compliant Applet is provided by a first entity and said native application is provided by a second entity,
wherein said method further comprises:
obtaining first and second input security criterion respectively defined by said first and second entities for enforcing security of said Java™ compliant and native application.

15. The computer-implemented method claim 13, wherein said method further comprises:
determining whether to provide said at least one security criterion to said Operating System and/or said virtual computing environment;
providing said at least one security criterion only to said Operating System when said determining determines to provide said at least one security criterion only to said Operating System;
providing said at least one security criterion only to said virtual computing system when said determining determines to provide said at least one security criterion only to said virtual computing system; and
providing said at least one security criterion in a same form to Operating System and said Virtual Computing Environment when said determining determines to provide said at least one security criterion to said Operating System and said virtual computing environment.

16. The computer-implemented method claim 1, wherein said generating, based on said input security criterion, at least one consistent security criteria comprises:
generating said at least one security criterion in a form including first and second parts respectively for said Operating System and said virtual computing environment.

17. The computer-implemented method of claim 16,
wherein said first part of said least one security criterion includes operating-system security labels for said Operating System, and
wherein said second part of said least one security includes one or more of the following:
virtual-computing security labels for said computing environment, and
a security-label mapping that effectively allows mapping of said virtual-computing security labels to said operating-system security labels.

18. The computer-implemented method of claim 1,
wherein said computing system is and/or includes one or more of the following:
a mobile and/or portable device, a Smartphone, a cell phone.

19. The computer-implemented method of claim 18,
wherein said computing system is further operable to support third computer executable code effectively provided by a third entity; and
wherein said Operating System is operable to enforce said at least one security criterion for execution of said third computer executable code.

20. A computer-implemented method of securing a computing system that includes: (a) an Operating System operable to effectively support execution of at least a first executable computer code (b) a Virtual Computing Environment operable to support execution of at least a second computer code, wherein said computer-implemented method comprises:
obtaining a first consistent security criterion for enforcement of a security criterion in a consistent manner with respect to said first executable computer code and second computer code; and
enforcing security in said computing system in accordance with said first consistent security criterion, thereby enforcing security in a consistent manner with respect to said first executable computer code and second computer code.

21. The computer-implemented method of claim 1, wherein said enforcing of said security comprises one or more of the following:
enforcing said first consistent security criterion with respect to execution of said first executable computer code and/or second computer code;
determining, based on said first consistent security criterion, a security decision with respect to said first executable computer code and/or second computer code; and
determining, based on said first consistent security criterion, whether to allow said first executable computer code and/or second computer code to access an accessible resource.

22. The computer-implemented method of claim 21, wherein said computer-implemented method further comprises:
obtaining an input security criterion for enforcement of security in a consistent manner with respect to execution of: (a) said first executable computer code effectively supported by said Operating System, and (b) said second computer code effectively supported by said virtual computing environment; and
generating, based on said input security criterion, said at least one consistent security criteria.

23. A computing system, wherein said computing system includes:
an Operating System operable to:
support at least a first executable computer code;
store a set of security criteria for securing said computing system; and
enforce a set of security criteria; and
a Virtual Computing Environment operable to:
support execution of at least a second computer code;
obtain from said Operating System at least one of a set of security criteria; and
enforce said at least one security criterion with respect to said second computer code operable to execute in said Virtual Computing Environment.

24. The computing system of claim 23, wherein said set of operating-system security criterion are a consistent set of consistent security criterion defined for enforcement of security in a consistent manner with respect to: (a) said first executable computer code effectively supported by said Operating System and (b) said second computer code supported by said virtual computing environment.

25. The computing system of claim 23, wherein said Virtual Computing Environment includes an operating-system aware component operable to:
interface with said Operating System by an operating-system security interface
to obtain said at least one security criterion; and
enforce said at least security criterion with respect to said second computer effectively supported by said Virtual Computing Environment as said operating-system security control component would enforce said operating-system security criterion with respect to said first executable computer code.

26. The computing system of claim 25, wherein said operating-system security interface includes a Programming Interfaces and/or a Library.

27. The computing system of claim 26,
wherein said Operating System is a Security-Enhanced Linux (SELinux), and
wherein said Programming Interface and/or Library include a SELinux library, thereby allowing said operating-system security interface to be effectively provided by using said SELinux library.

28. The computing system 27, wherein said computing environment is further operable to map one or more virtual-computing security labels to one or more operating-system security labels.

29. A computer readable storage medium storing in a tangible form at least executable computer code for a Virtual Computing Environment operable to support a Virtual Computing Environment for execution of computer code, wherein said computer readable storage medium includes:
executable computer code operable to obtain from an Operating System at least one security criterion that can be effectively enforced by said Operating System with respect to first executable computer code supported by said Operating System; and
executable computer code operable to enforce said security criterion with respect to a second computer code operable to execute in said virtual computing environment, thereby effectively enforcing a security criteria that can be enforced by said Operating System.
